(19) United States
(12) Patent Application Publication
(10) Pub. No.: US 2011/0219709 A1
(43) Pub. Date: Sep. 15, 2011

(54) Cover/Wrap/Envelope for a Gravestone, Monument, Headstone, Tomb or marker placed at the head of a Grave

(76) Inventor: Cheryl A. Leyden, Dudley, MA (US)

(21) Appl. No.: 12/719,862

(22) Filed: Mar. 9, 2010

(51) Int. Cl. E04H 13/00; A61G 99/00

(52) U.S. Cl. 52/103; 52/173.1

(57) ABSTRACT

A grave marker apparatus that has four walls and a top for displaying computer generated text, graphics, images and the like, atop and/or around a head stone. The four walls and top form a five sided cover that allows maximum graphic display space for a variety of differently shaped headstones. Velcro buttons or like material accommodates temporary attachments without damaging the marker or landscaping around the stone. The device also covers flat grave markers and faceplate markers using one wall.

### FIELD OF THE INVENTION

This application emanates from a previously filed provisional application 61/152309 filed on Feb. 13, 2009

### FIELD OF THE INVENTION

The present invention relates generally to an apparatus and method for displaying graveside adornment, such as computer generated graphics, images, photos and the like, atop and over grave marking stones. Particularly, this invention relates to a removable adornment graphic cover that may be mounted on a variety of grave marking stones without damaging or marking the stone.

### BACKGROUND OF THE INVENTION

Headstones, also typically referred to as tombstones or gravestones, come in a variety of shapes, sizes and surfaces. It is customary to place flowers or other decorations adjacent to or on headstones or other grave markers. Cemetery groundskeepers find that memorials placed on the ground near a grave become obstacles which are difficult to maneuver around while mowing and trimming. Consequently, cemeteries have promulgated rules that require decorations placed on the ground, such as flowers, plants, plastic flowers and the like, to be removed prior to the days that mowing and trimming is to occur. Persons placing such decorations near a grave typically wish for them to be displayed as long as possible, sometimes even permanently, and are greatly inconvenienced by the need to return to the grave site to remove such decorations periodically.

Present methods of displaying flowers and other adornment objects out of the way of the cemetery groundskeepers include such complex mechanisms as the combination grave marker and flower receptacle shown in U.S. Pat. No. 4,1722,160 (1988, C. Davis). Davis discloses a grave marker which has a cover on its top face that can be opened to expose a flower receptacle. This cover, when not being used to display flowers, can be folded down and out of the way, thereby allowing for easy maintenance around the grave marker, or even over the grave marker if it is mounted flush with the ground. Regardless of which position the cover is in, this grave marker does not interfere with normal cemetery maintenance.

Another device to keep grave site adornments off the ground is disclosed in U.S. Pat. No. 4,640,045 (1987, R. Nesbitt et al). This patent discloses a saddle that has been adapted to be clamped to the top portion of a headstone. A holding structure, such as a planter box, is then attached to the saddle and decorative objects can be displayed out of the way of lawnmowers or other cemetery trimming machines.

U.S. Pat. No. 5,072,542 (1991, D. Quackenbush) discloses another type of saddle planter adapted to be mounted on a gravestone. This saddle planter is attached to the gravestone by brackets with cushioned legs that are designed to supply forces to the front and rear of the gravestone, thereby holding the saddle planter in place while also preventing scratching and marking of the gravestone. Containers of various sizes can be attached to this saddle planter so that the size of the floral display can be enlarged.

An adjustable saddle which can be used on either grave markers or porch deck railings is disclosed in U.S. Pat. No. 5,368,266 (1994, N. Allen). This adjustable saddle is secured on the top of a grave marker or porch deck railing by spring-mounted opposing pairs of legs. Decorative objects, such as a planter box, can then be attached to the saddle and ornamental objects can be displayed.

What is needed is a custom designed graphic cover being used on a variety of differently shaped grave stone markers. What is also needed is a cover that has no moving parts, won't damage the headstone and is readily removable from the headstone. What is further needed is a device that will stand up to long term continual use and be conducive to a modern day image adornment.

### SUMMARY OF THE INVENTION

It is thus an object of the invention to provide a graphically designed article made of all weather durable materials to adorn grave markers.

It is a further object of the invention to provide an easily removable decorative grave marker cover/wrap/envelope for the graphical illustrations and descriptive art without damaging the grave marker.

The graphic cover/wrap/envelope comes in three types/styles/categories; headstone, flat ground or faceplate.

### General:

A corrugated plastic product such as Coroplast or like material, which is a high quality polypropylene twin-wall sheet, is the base material of the apparatus. The gauged width size of Coroplast or like material to be used for the device is determined by the user. The sheets are cut and formed to build the size of the apparatus. On-site measurements of the gravestone marker are taken which dictate the dimensions of the device chosen.

Computerized graphics are then transferred to a vinyl laminated digital print and adhered to the apparatus by heat.

Adhesion to the headstone marker, ground marker or faceplate marker is accomplished by using Velcro buttons attached to the interior side/sides of the apparatus and the exterior side/sides of the marker.

### Headstone Cover/Wrap/Envelope:

A headstone cover apparatus dimensions will be oversized by approximately ½″ to 1″ on all five sides from the recorded measurements of the gravestone marker. The base/foundation of the headstone marker is not covered by the device. It's a “box” with no bottom.

The headstone cover is formed by commercial grade box packing tape joining separated interior walls and the top wall. Externally, the edges or seams are joined together by the vinyl laminated digital print adhered by heat.

### Flat Ground or Faceplate Cover/Wrap/Envelop:

A flat ground or faceplate apparatus would replicate the measurement size of the marker and the graphics would be on the exterior side visibly seen by an onlooker.

### BRIEF DESCRIPTION OF DRAWINGS

FIG. 1: FIG. 1 depicts two different applications of the apparatus. The top illustration is the side view for a faceplate apparatus and the bottom illustration is the side view for a flat ground apparatus.

The faceplate apparatus illustration depicts Velcro button mounting straps (1) on the inner side of the device (2) and on the outer side of the faceplate marker (3) so it can be mounted securely to the faceplate marker.

The flat ground apparatus illustration depicts Velcro button mounting straps (1) on the inner side of the device (2) and on the outer side of the ground marker (3) so it can be mounted securely to the ground marker.

FIG. 2: FIG. 2 is the front and side view of the headstone apparatus. The device is equipped with Velcro button mounting straps (1) on the inner side of the device (7) and on the outer side of the gravestone, monument, headstone, tomb or marker (6) so it can be mounted securely to the gravestone, monument, headstone, tomb or marker.

### DETAILED DESCRIPTION OF DRAWINGS

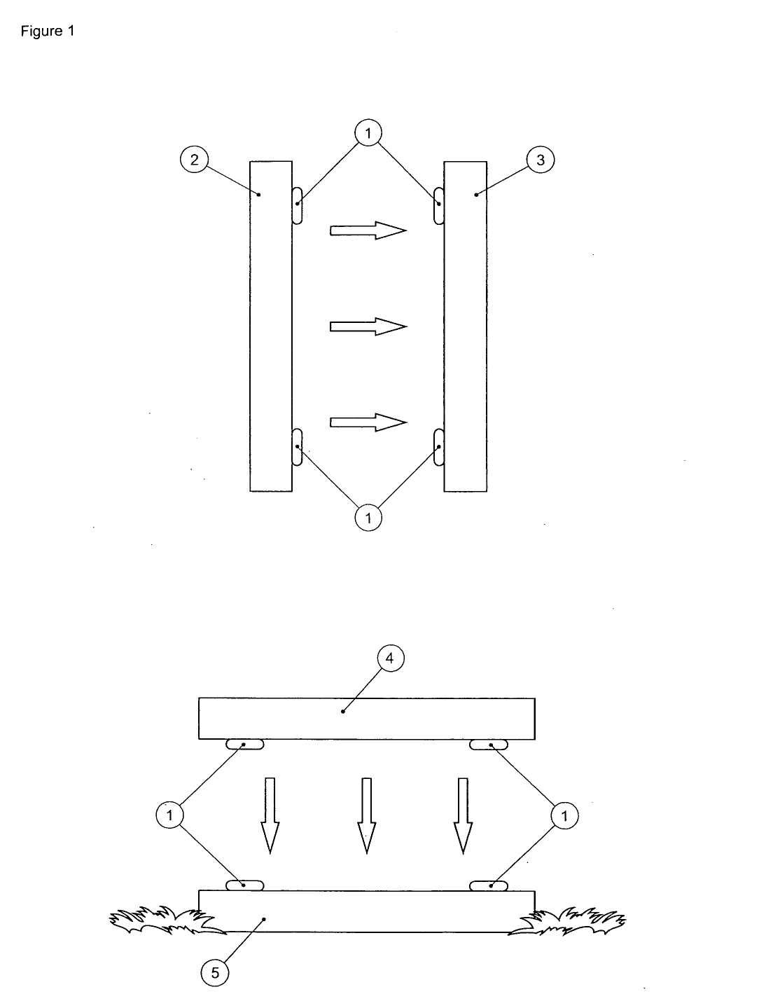

Referring to the faceplate apparatus illustration in FIG. 1, the device for a faceplate marker is equipped with four or more mounting straps (1) such as Velcro buttons. The mounting straps (1) are fastened to the inner side of the device (2) and to the exterior or outer side of the faceplate marker (3) to be covered. The device (2) can be easily attached or removed with the mounting straps (1). The device (2) will have the computerized graphics on the outer side of the device, visible to the eye.

Referring to the flat ground apparatus illustration in FIG. 1, the device for a ground marker is equipped with four or more mounting straps (1) such as Velcro buttons. The mounting straps (1) are fastened to the inner side of the device (2) and to the exterior or outer side of the ground marker (3) to be covered. The device (2) can be easily attached or removed with the mounting straps (1). The device (2) will have the computerized graphics on the outer side of the device, visible to the eye.

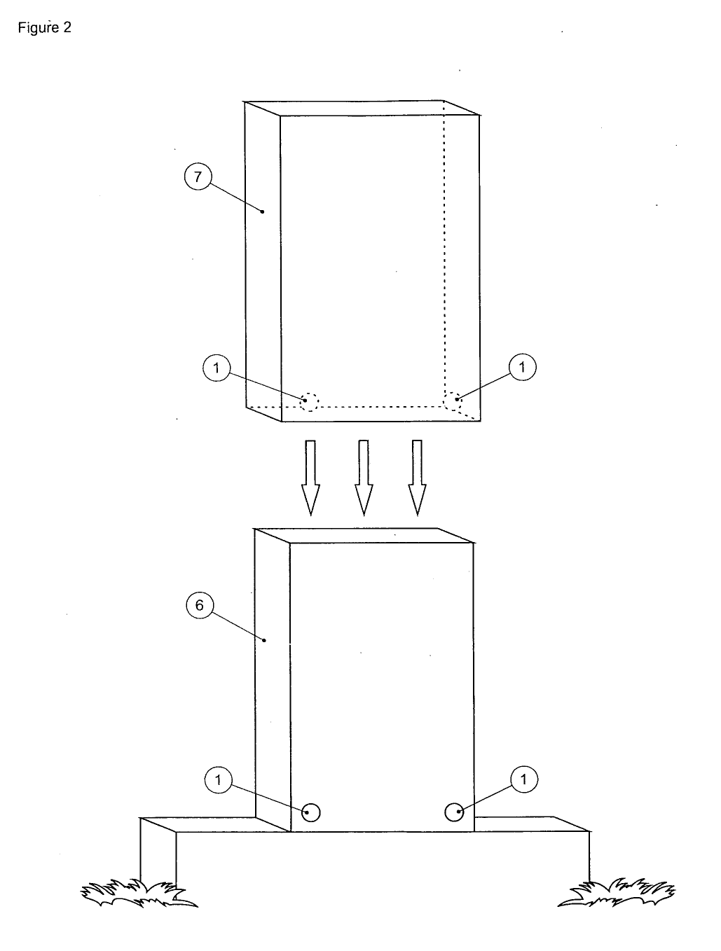

Referring to the headstone apparatus illustration in FIG. 2, the device is equipped with four or more mounting straps (1) such as Velcro buttons on the inner side of the device (7) so it can be mounted securely to the gravestone, monument, headstone, tomb or marker (6). The device (7) is comprised of five sides and is slipped over the gravestone, monument, headstone, tomb or marker (6) and can easily be removed by disengaging the mounting straps (1). The mounting straps (1) can be excluded if so desired by the user. The device (7) will have the computerized graphics on the outer side or sides of the device, visible to the eye.

1. An apparatus and method for displaying a weather durable, removable graveside adornment for a headstone marker and a ground marker and a faceplate marker comprising; a personalized computer graphic display transferred to vinyl laminated digital print adhered by heat onto a corrugated plastic product such as coroplast and like material and fastened to the said markers with or without velcro buttons and like material and custom fitted to cover the exterior of the marker by replicating the size of the marker.

2. The gauged width size of coroplast and like material recited in claim 1 is determined by the end user.

3. The apparatus for the headstone, ground and faceplate marker recited in claim 1 does not cover the foundation or base of a headstone, ground and faceplate marker.

4. The coroplast and like material recited in claim 1 is waterproof.

5. The vinyl laminated digital print recited in claim 1 provides UV protection.

6. The apparatus for the headstone marker recited in claim 1 is comprised of four walls and a top forming a five sided cover over sizing the original marker by approximately ½″ to 1″ on all five sides resting stationary on the foundation of the marker.

7. The apparatus for the headstone marker recited in claim 3 is formed by commercial grade box packing tape joining separated interior walls and top and externally by the vinyl laminated digital print adhered by heat.

8. The apparatus for the ground marker and faceplate marker recited in claim 1 is comprised of one top covering the marker with the exterior side of the top displaying the vinyl laminated digital print adhered by heat, fastened to the marker with velcro buttons.

9. The application and removal method of the apparatus to and from the headstone marker and ground marker and faceplate marker recited in claim 1 is achieved by engaging or disengaging the velcro buttons without damaging the marker.
